(19) United States
(12) Patent Application Publication
(10) Pub. No.: US 2023/0108279 A1
(43) Pub. Date: Apr. 6, 2023

(54) BEARING ARRANGEMENTS FOR A DISCONNECTABLE WHEEL ASSEMBLY

(71) Applicant: Schaeffler Technologies AG & Co. KG, Herzogenaurach (DE)

(72) Inventors: Shakeel SHAIKH, Windsor (CA); Zheng WANG, Rochester Hills, MI (US)

(73) Assignee: Schaeffler Technologies AG & Co. KG, Herzogenaurach (DE)

(21) Appl. No.: 17/824,233

(22) Filed: May 25, 2022

Related U.S. Application Data
(60) Provisional application No. 63/250,618, filed on Sep. 30, 2021.

(51) Int. Cl. F16C 19/16; F16C 33/58

(52) U.S. Cl. CPC F16C 19/16; F16C 33/583

(57) ABSTRACT

A wheel bearing arrangement for a disconnectable wheel assembly which includes a drive shaft that is adapted to be drivingly engaged with or disengaged from a wheel supporting flange and an assembly method are provided. The arrangement includes first and second deep groove ball bearings located between the shaft and the flange. The first inner ring of the first bearing is axially positioned by a shaft shoulder on the shaft and the first outer ring is axially positioned by a first flange shoulder on the flange. The second outer ring of the second bearing has an interference fit with the flange in a radial direction. For some options, a spacer axially separates the first and second inner rings. A nut is engaged to an end of the shaft and clamps the second inner ring, the spacer, and the first inner ring to the shaft shoulder. Alternate arrangements are also provided.

### CROSS-REFERENCE TO RELATED APPLICATIONS

This application is the a non-provisional that claims the benefit of U.S. Provisional Appln. No. 63/250,618, filed Sep. 30, 2021, the entire disclosure of which is incorporated by reference herein.

### TECHNICAL FIELD

The disclosure relates to a disconnectable wheel assembly, and more particularly to a wheel bearing arrangement for such an assembly.

### BACKGROUND

FIG. 1 is a schematic cross-section of a prior art disconnectable wheel assembly in the disconnected state. The knuckle 10 is part of the suspension / steering system, which locates the axis of rotation 12 of the wheel relative to vehicle structure. The knuckle 10 does not rotate about the axis 12. A flange 14 is provided that is adapted for connection to the wheel hub and is supported for rotation about axis 12 by a first bearing arrangement 16. While in the disconnected state, shaft 18 is supported by a second bearing arrangement 20 for rotation relative to the flange 14. Relative rotation includes a situation in which shaft 18 is stationary and flange 14 rotates. The bearing arrangement 20 locates shaft 18 axially and radially while imposing negligible resistance to rotation. A connector 22 is rotationally fixed to shaft 18 but can move axially. A gear 24 is rotationally fixed to flange 14. To transition from the disconnected state to a connected state, the connector 22 is moved axially to engage the gear 24. In the connected state, the shaft 18 can transmit torque to the flange 14 to propel the vehicle.

A more robust support for the shaft is desired that is simple to assemble and avoids potential structural and noise issues.

### SUMMARY

According to the disclosure, a wheel bearing arrangement for a disconnectable wheel assembly which includes a drive shaft that is adapted to be drivingly engaged with or disengaged from a wheel supporting flange is provided.

In one embodiment, the wheel bearing arrangement comprises a first deep groove ball bearing located on the shaft, with the first deep groove ball bearing including a first inner ring, a first outer ring, and rollers located therebetween. The first inner ring is axially positioned by a shaft shoulder on the shaft and the first outer ring is axially positioned by a first flange shoulder on the flange. The arrangement further includes a second deep groove ball bearing located on the shaft, with the second deep groove ball bearing including a second inner ring, a second outer ring, and rollers located therebetween. The second outer ring has an interference fit with the flange in a radial direction. A spacer axially separates the first and second inner rings. A nut is engaged to an end of the shaft and clamps the second inner ring, the spacer, and the first inner ring to the shaft shoulder.

With this arrangement, radial and tilting loads on the shaft are transmitted to the flange by radial forces through the first and second bearings and axial forces in a first direction via the shaft shoulder, the first inner ring, the rollers of the first bearing, the first outer ring, and the flange shoulder and in a second direction via the nut, the second inner ring, the rollers of second bearing, the second outer ring, and the interference fit between second outer ring and the flange.

In one configuration, the first and second inner rings are located on the shaft.

Alternatively, in another configuration, the spacer includes spacer flanges at each axial end, and the first and second inner rings are located on the spacer flanges.

In each of these cases, the spacer has a sliding fit with the shaft.

In one embodiment, the flange includes a second flange shoulder that faces the second outer ring and the spacer has an axial length between the first and second ball bearings to maintain a clearance between the second outer ring and the second flange shoulder.

In one embodiment, the first and second ball bearings have a same size. However, the sizes could be varied depending upon the particular application.

A further embodiment is provided for the wheel bearing arrangement for a disconnectable wheel assembly which includes a drive shaft that is adapted to be drivingly engaged with or disengaged from a wheel supporting flange. In this embodiment, the wheel bearing arrangement comprises a first deep groove ball bearing located on the shaft, with the first deep groove ball bearing including a first inner ring, a first outer ring, and rollers located therebetween. The first inner ring of the first ball bearing is positioned between a first shaft shoulder on the shaft and a first flange shoulder on the flange. The arrangement further includes a second deep groove ball bearing located on the shaft, with the second deep groove ball bearing including a second inner ring, a second outer ring, and rollers located therebetween. The second inner ring is positioned against a second shaft shoulder on the shaft and the second outer ring is positioned against a second flange shoulder on the flange. A snap ring is engaged in a groove in the flange that holds the second outer ring axially in position against the second flange shoulder, and a nut is engaged to an end of the shaft that clamps the second inner ring against the second shaft shoulder.

Here, the first bearing is a floating bearing relative to the shaft which is not intended to transmit axial forces, while the second bearing’ is a locating bearing intended to transmit axial forces in both directions. Radial forces are transmitted to the flange through both the first and second bearings.

In one arrangement, the first and second inner rings are located on the shaft with a loose fit.

In one arrangement, the first ball bearing is floating and the second ball bearing is configured to transmit loads in both axial directions.

Here again, the second ball bearing must have a smaller bore diameter than the second bearing for assembly. However, the outer diameter could be varied depending upon the particular application.

In another aspect, a method of assembling a wheel bearing arrangement for a disconnectable wheel assembly which includes a drive shaft that is adapted to be drivingly engaged with or disengaged from a wheel supporting flange is also provided. The method includes:
providing a first deep groove ball bearing including a first inner ring, a first outer ring, and rollers located therebetween, and inserting the first bearing into the flange such that the first outer ring is axially positioned by a first flange shoulder on the flange;
placing a spacer that contacts the first inner ring;
providing a second deep groove ball bearing including a second inner ring, a second outer ring, and rollers located therebetween, and inserting the second bearing into the flange and pushing against both the second inner ring and the second outer ring at a same time to maintain axial alignment between the rings while moving the second bearing to an installed position in which the second outer ring has an interference fit with the flange in a radial direction and the second inner ring contacts the spacer;
inserting the shaft into the first inner ring, the spacer and the second inner ring; and
installing a nut onto an end of the shaft to clamp the second inner ring, the spacer, and the first inner ring to the shaft shoulder.

In use, radial and tilting loads on the shaft are transferred to the flange by radial forces through the first and second bearings and axial forces in a first direction via the shaft shoulder, the first inner ring, the rollers of the first bearing, the first outer ring, and the flange shoulder and in a second direction via the nut, the second inner ring, the rollers of second bearing, the second outer ring, and the interference fit between second outer ring and the flange.

As noted above, optionally the spacer can include spacer flanges at each axial end, and the first and second inner rings can be located on the spacer flanges.

In one arrangement, the flange includes a second flange shoulder that faces the second outer ring, and the spacer has an axial length between the first and second ball bearings to maintain a clearance between the second outer ring and the second flange shoulder.

Various features of the invention can be used alone or in combination in order to achieve one or more of the benefits described herein.

### BRIEF DESCRIPTION OF THE DRAWINGS

The foregoing Summary and the following detailed description will be better understood when read in conjunction with the appended drawings, which illustrate preferred embodiments according to the disclosure. In the drawings:

FIG. 1 is a schematic cross-section of a prior art disconnectable wheel assembly in the disconnected state.

FIG. 2 is a schematic cross-sectional view of a first embodiment of a bearing arrangement according to the disclosure.

FIG. 3 is a schematic cross-sectional view of a second embodiment of a bearing arrangement according to the disclosure.

FIG. 4 is a schematic cross-sectional view of a third embodiment of a bearing arrangement according to the disclosure.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. The words “inwardly” and “outwardly” refer to directions toward and away from the parts referenced in the drawings. “Axially” refers to a direction along the axis of a shaft. “Radially” refers to a direction normal to an axis. “Left” and “Right” refer to directions of various parts in the drawings only and the entire arrangements disclosed can be reversed in practice and still be considered “Left” and Right”. A reference to a list of items that are cited as, for example, “at least one of a or b” (where a and b represent the items being listed) means any single one of the items a or b, or a combination of a and b thereof. This would also apply to lists of three or more items in like manner so that individual ones of the items or combinations thereof are included. The terms “about” and “approximately” encompass + or - 10% of an indicated value unless otherwise noted. The terminology includes the words specifically noted above, derivatives thereof and words of similar import. A sliding fit between parts includes a clearance of 0.0003 to 0.005 in. A close or tight radial fit can be a zero clearance (interference) to 0.010 in. A loose fit can be from 0.010 to 0.030 in. As will be understood by those skilled in the art, these fits may be increased as the scale of the interfacing parts increases.

Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

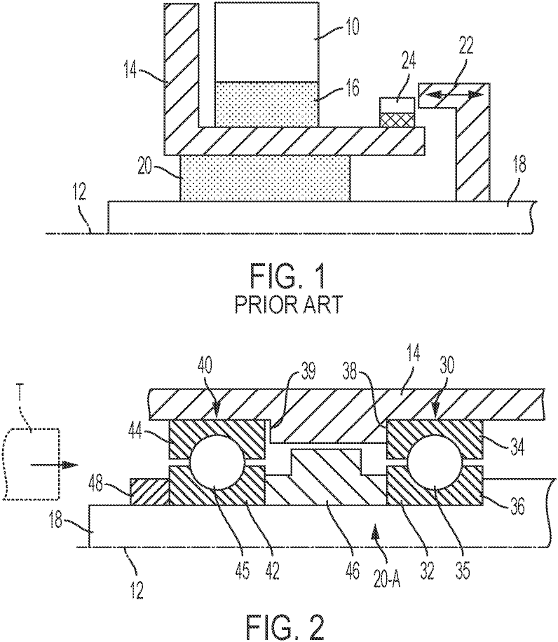

FIG. 2 illustrates a first embodiment of a bearing arrangement 20-A configured for supporting the shaft 18, which can be for example a half-shaft, relative to a wheel supporting flange 14, which is adapted to support and/or otherwise be connected to a wheel hub. A first deep grove ball bearing 30 is installed between the flange 14 and the shaft 18. The first bearing 30 has a first inner ring 32 and a first outer ring 34, with first rollers 35, preferably balls, located therebetween. The first inner ring 32 is axially positioned by a shaft shoulder 36 on the shaft 18 and the first outer ring 34 is axially positioned by a first flange shoulder 38 on the flange 14. The first inner ring 32 and the first outer ring 34 are dimensioned to provide a sliding radial fit with the shaft 18, and an interference fit, with the flange 14, respectively. The first bearing 30 may be inserted into the flange 14 prior to inserting the shaft 18 into the flange 14.

A second deep groove ball bearing 40 is provided that includes a second inner ring 42 and a second outer ring 44, with second rollers 45, preferably balls, located therebetween. The second inner ring 42 is dimensioned to provide a sliding radial fit with the shaft 18. The second outer ring 44 is dimensioned to provide an interference fit with the flange 14 in the radial direction. A spacer 46 axially separates the first and second inner rings 32 and 42. The second bearing 40 is pushed into place axially after the first bearing 30 and the spacer 46 are positioned with respect to flange 14. A tool (indicated in broken lines at T and having an annular form) is preferably used to push second bearing 40 axially and pushes against both the second inner ring 42 and the second outer ring 44 to maintain axial alignment between the rings. The second bearing 40 is pushed until all axial space is taken up between second inner ring 42, the spacer 46 and the first inner ring 32. Although the second outer ring 44 is shown near a second flange shoulder 39 of the flange 14, the spacer 46 is dimensioned axially to provide axial clearance to any such shoulder. The spacer 46 is dimensioned radially to provide radial clearance to the flange 14. After the second bearing 40 has been pushed into place (and the tool T removed), the shaft 18 is inserted and a nut 48 is threaded onto the shaft 18 that clamps the second inner ring 42, the spacer 46, and the first inner ring 32 against the shaft shoulder 36.

Radial and tilting loads on the shaft 18 are transmitted to the flange 14 by radial forces through the first and second bearings 30 and 40. Axial loads from the right on shaft 18 are transmitted to the flange 14 via the shaft shoulder 36, the first inner ring 32, the rollers of the first bearing 30, the first outer ring 34 and the first flange shoulder 38. Axial forces from the left on the shaft 18 are transmitted to the flange 14 via the nut 48, the second inner ring 42, the rollers of second bearing 40, the second outer ring 44, and the interference fit between the second outer ring 44 and the flange 14.

The first and second bearings 30, 40 can be the same size, or the sizes can be different depending on the particular application.

The connector 22 that is rotationally fixed to the shaft 18 that can move axially can be as explained above in connection with FIG. 1, with a splined connection between the connector 22 and the shaft 18 to allow for the axial movement. The gear 24 as explained above can be rotationally fixed to flange 14, and the connector 22 is moved axially to engage with or disconnect from the gear 24.

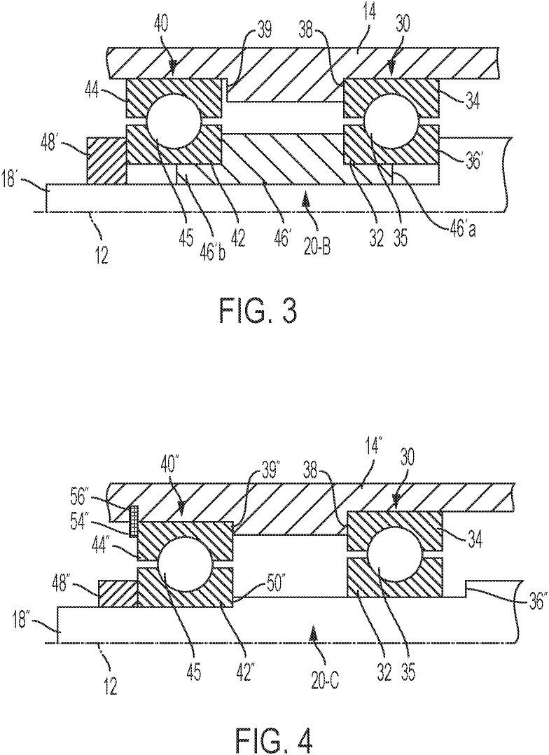

FIG. 3 illustrates a second embodiment of a bearing arrangement 20-B configured for supporting the shaft 18' relative to the flange 14. Parts that are unchanged from bearing arrangement 20-A are labeled with the same reference number. Parts that are modified, but have essentially the same roles are labeled with a prime ('). In this arrangement, the shaft shoulder 36' is deeper than in the arrangement 20-A. The spacer 46' is radially located by the first and second inner rings 32 and 42 and includes spacer flanges 46'a, 46'b at each axial end on which the first and second inner rings 32, 42 are located. The shaft 18 is supported by the spacer 46', which preferably has a sliding fit with the shaft 18. The assembly process and the axial loads paths are essentially the same as in assembly 20-A.

The first and second bearings 30, 40 in the bearing arrangement 20-B can also be the same size, or the sizes can be different depending on the particular application.

The connector 22 that is rotationally fixed to the shaft 18' that can move axially can be as explained above in connection with FIG. 1, with a splined connection between the connector 22 and the shaft 18' to allow for the axial movement. The gear 24 as explained above can be rotationally fixed to flange 14, and the connector 22 is moved axially to engage with or disconnect from the gear 24.

FIG. 4 illustrates a third embodiment of a bearing arrangement 20-C suitable for supporting the shaft 18ʺ relative to the flange 14ʺ. Parts that are unchanged from bearing arrangement 20-A are labeled with the same reference number. Parts that are modified, but have similar roles as well as parts that are specific to this embodiment are labeled with a double prime (ʺ). In this arrangement, the first bearing 30 is a floating bearing which is not intended to transmit axial forces, while the second bearing 40ʺ is a locating bearing intended to transmit axial forces in both directions. The first and second outer rings 34, 44ʺ have a tight fit with the flange 14ʺ. The first and second inner rings 32, 42ʺ have a loose fit with the shaft 18ʺ. The second inner ring 42ʺ is held axially against a second shaft shoulder 50ʺ of the shaft 18ʺ by a nut 48ʺ. The second outer ring 44ʺ axially abuts a second flange shoulder 39ʺ of flange 14ʺ and is held axially by a snap ring 54ʺ that is engaged in a groove 56ʺ in the flange 14ʺ. Axial loads from the right on the shaft 18ʺ are transmitted to the flange 14ʺ via the second shaft shoulder 50ʺ, the inner ring 42ʺ, the rollers of second bearing 40ʺ, the second outer ring 44ʺ and the snap ring 54ʺ. Axial forces from the left on the shaft 18ʺ are transmitted to the flange 14ʺ via the nut 48ʺ, the second inner ring 42ʺ, the rollers of the second bearing 40ʺ, the second outer ring 44ʺ, and the second flange shoulder 39ʺ of flange 14ʺ.

The first and second flange shoulders 38, 39ʺ define a minimum spacing between the first and second ball bearings 30, 40.

The second bearing 40ʺ has a smaller bore diameter than the first bearing 30. The outer diameters of both bearings can be the same size, or the sizes can be different depending on the particular application.

The connector 22 that is rotationally fixed to the shaft 18ʺ that can move axially can be as explained above in connection with FIG. 1, with a splined connection between the connector 22 and the shaft 18ʺ to allow for the axial movement. The gear 24 as explained above can be rotationally fixed to flange 14ʺ, and the connector 22 is moved axially to engage with or disconnect from the gear 24.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

### List of Reference Characters

10 knuckle
12 axis
14, 14ʺ flange
16 first bearing arrangement
18, 18ʹ, 18ʺ shaft
20 second bearing arrangement
22 connector
24 gear
20-A first embodiment of a bearing arrangement
20-B second embodiment of a bearing arrangement
20-C third embodiment of a bearing arrangement
30 first deep groove ball bearing
32 first inner ring
34 first outer ring
35 rollers or balls
36, 36ʹ, 36ʺ shaft shoulder
38 first flange shoulder
39, 39ʺ second flange shoulder
40, 40ʺ second deep groove ball bearing
42, 42ʺ second inner ring
44, 44ʺ second outer ring
45 rollers or balls
46,46ʹ spacer
46ʹa, 46ʹb spacer flanges
48, 48ʹ, 48ʺ nut
50ʺ second shaft shoulder
54ʺ snap ring
56ʺ groove

1. A wheel bearing arrangement for a disconnectable wheel assembly which includes a drive shaft that is adapted to be drivingly engaged with or disengaged from a wheel supporting flange, the wheel bearing arrangement comprising:
a first deep groove ball bearing located on the shaft, the first deep groove ball bearing including a first inner ring, a first outer ring, and rollers located therebetween, the first inner ring is axially positioned by a shaft shoulder on the shaft and the first outer ring is axially positioned by a first flange shoulder on the flange;
a second deep groove ball bearing located on the shaft, the second deep groove ball bearing including a second inner ring, a second outer ring, and rollers located therebetween, the second outer ring has an interference fit with the flange in a radial direction;
a spacer axially separating the first and second inner rings; and
a nut engaged to an end of the shaft that clamps the second inner ring, the spacer, and the first inner ring to the shaft shoulder.

2. The wheel bearing arrangement of claim 1, wherein the first and second inner rings are located on the shaft with a sliding fit.

3. The wheel bearing of claim 1, wherein the spacer includes spacer flanges at each axial end, and the first and second inner rings are located on the spacer flanges.

4. The wheel bearing of claim 3, wherein the spacer has a sliding fit with the shaft.

5. The wheel bearing of claim 1, wherein the flange includes a second flange shoulder that faces the second outer ring and the spacer has an axial length between the first and second ball bearings to maintain a clearance between the second outer ring and the second flange shoulder.

6. The wheel bearing of claim 1, wherein the first and second ball bearings have a same size.

7. A wheel bearing arrangement for a disconnectable wheel assembly which includes a drive shaft that is adapted to be drivingly engaged with or disengaged from a wheel supporting flange, the wheel bearing arrangement comprising:
a first deep groove ball bearing located on the shaft, the first deep groove ball bearing including a first inner ring, a first outer ring, and rollers located therebetween, the first ball bearing is positioned by a first flange shoulder on the flange;
a second deep groove ball bearing located on the shaft, the second deep groove ball bearing including a second inner ring, a second outer ring, and rollers located therebetween, the second inner ring is positioned against a second shaft shoulder on the shaft and the second outer ring is positioned against a second flange shoulder on the flange,
a snap ring engaged in a groove in the flange that holds the second outer ring axially in position against the second flange shoulder; and
a nut engaged to an end of the shaft that clamps the second inner ring against the second shaft shoulder.

8. The wheel bearing arrangement of claim 7, wherein the first and second inner rings are located on the shaft with a loose fit.

9. The wheel bearing arrangement of claim 7, wherein the first ball bearing is floating relative to the shaft and the second ball bearing is configured to transmit loads in both axial directions.

10. The wheel bearing of claim 7, wherein the first and second ball bearings have different bore diameters.

11. A method of assembling a wheel bearing arrangement for a disconnectable wheel assembly which includes a drive shaft that is adapted to be drivingly engaged with or disengaged from a wheel supporting flange, the method comprising:
providing a first deep groove ball bearing including a first inner ring, a first outer ring, and rollers located therebetween,
inserting the first bearing into the flange such that the first outer ring is axially positioned by a first flange shoulder on the flange;
placing a spacer that contacts the first inner ring;
providing a second deep groove ball bearing including a second inner ring, a second outer ring, and rollers located therebetween;
inserting the second bearing into the flange and pushing against both the second inner ring and the second outer ring at a same time to maintain axial alignment between the rings while moving the second bearing to an installed position in which the second outer ring has an interference fit with the flange in a radial direction and the second inner ring contacts the spacer;
inserting the shaft into the first inner ring, the spacer, and the second inner ring; and
installing a nut onto an end of the shaft to clamp the second inner ring, the spacer, and the first inner ring to the shaft shoulder.

12. The method of claim 11, further comprising transferring radial and tilting loads on the shaft to the flange by radial forces through the first and second bearings and axial forces from the shaft to the flange in a first direction via the shaft shoulder, the first inner ring, the rollers of the first bearing, the first outer ring, and the flange shoulder and in a second direction via the nut, the second inner ring, the rollers of second bearing, the second outer ring, and the interference fit between second outer ring and the flange.

13. The method of claim 11, wherein the spacer includes spacer flanges at each axial end, and the first and second inner rings are located on the spacer flanges.

14. The method of claim 11, wherein the flange includes a second flange shoulder that faces the second outer ring, and the spacer has an axial length between the first and second ball bearings to maintain a clearance between the second outer ring and the second flange shoulder.
